(19) United States
(12) Patent Application Publication
(10) Pub. No.: US 2008/0033900 A1
(43) Pub. Date: Feb. 7, 2008

(54) System and method for autonomic tuning the number of threads in application server at runtime

(76) Inventors: Yan Zhang, Epping (AU); Wei Qu, Epping (AU)

Correspondence Address: YAN ZHANG, 15/25 BRIDGE STREET, EPPING, 2121, omitted

(21) Appl. No.: 11/832,016

(22) Filed: Aug. 1, 2007

Related U.S. Application Data
(60) Provisional application No. 60/821,358, filed on Aug. 3, 2006.

(51) Int. Cl. G06N 7/02

(52) U.S. Cl. 706/52

(57) ABSTRACT

An autonomic performance tuning system with a fuzzy control model is provided for autonomic tuning the number of threads in application server at runtime. It dynamically monitors and measures behaviours of an application server, feeds these measures into the fuzzy control model and uses the results derived from the fuzzy control model to adaptively tune the number of threads in the application server. This process is executed in a feedback-loop manner to provide optimal performance at all time. It frees administrators from manually tuning the number of threads and enables application server self-tuning and self-optimization.

### CLAIM OF PRIORITY

This application claims priority from provisional application entitled METHOD FOR ADJUSTING THE NUMBER OF THREADS DYNAMICALLY IN J2EE APPLICATION SERVER SYSTEMS, Application No. 60/821,358, filed on Aug. 3, 2006, by Yan Zhang, and incorporated herein by reference.

### FIELD OF THE INVENTION

The invention is related generally to application servers, and specifically to a system and method for tuning the number of threads in application server at runtime to optimise the performance of application server. The system and method can be further tailored to suit tuning other parameters in application server and to meet other system quality requirements such as security.

### BACKGROUND

In a typical e-business environment, application server resides in the middle tier of the multi-tiered e-business system architecture. Its role is to provide middleware services (for example, transactions, security and persistence) to deployed applications. FIG. 1 shows a typical topology of an application server deployment. In a Web application, an Internet browser 102 submits HTTP (hypertext transfer protocol) 104 requests to and downloads HTML (hypertext markup language) pages from a Web Server 106. The Web Server 106 directs requests to an application server 108. The application server 108 is connected to a back-end database 110 where persisted data are stored. In an application not deployed using a browser, stand-alone Java clients or applets 112 can be used, and these Java clients or applets 112 would communicate directly with the application server 108, using the Java Remote Method Invocation (RMI) 114 as the underlying protocol.

The performance of application server has important effect on the performance of the whole e-business system. Experience has shown that the actual number of threads in application server used to serve the requests from clients has a significant impact on the performance of application server. Therefore, it is critical to tune the number of threads in application server. Current application servers have provided thread pool size parameter for administrator to manually adjust the number of threads in application server. However, figuring out the optimal thread pool size (number of threads) is not an easy task.

In practice, administrators experimentally discover the thread pool size that provide the desired levels of performance via performance testing using some industry benchmarks or in-house applications given certain workloads. However, the experimental approach is a time-consuming, expensive and non-trivial method. It requires highly skilled personnel. In addition, since the workloads of e-business sites tend to vary dynamically and exhibit fluctuations, even if the thread pool size is tuned well at one point in time, it will show poor performance at other times. That is, a statically tuned system will perform poorly in the time-varying workloads as present in typical e-business environment.

Therefore, what is needed is a means for automatically tuning the number of threads in application server at runtime to achieve optimal system performance at all time.

### SUMMARY

An objective of the present inventions is to optimise the performance of application server.

A further objective of the present invention is to eliminate manual tuning effort and to enable application server self-tuning and self-optimization.

In accordance with an embodiment of the invention, a system and method for autonomic tuning the number of threads in application server at runtime is provided. In accordance with an embodiment, an autonomic performance tuning system is built to perform monitoring, decision and tuning operations on application server without human intervention. A fuzzy control model is constructed and used in the autonomic performance tuning system. A fuzzy inference engine in the fuzzy control model makes decisions on whether the number of threads needs to be adjusted or not and how many threads should be increased or decreased based on the fuzzy control algorithm and fuzzy rules in the rule base in the fuzzy control model.

In accordance with an embodiment of the invention, during runtime, the system collects the response time of clients' requests and the number of threads handing the requests in application server; the collected response time and the number of threads are fed into the fuzzy control model; the fuzzy inference engine in the fuzzy control model subsequently evaluates activation strength of the available fuzzy rules in the rule base, combines their rule-consequent sides and determines whether the number of threads needs to be adjusted or not and how many threads should be increased or decreased; the results derived from the fuzzy inference engine are translated into actions on the running application server. This process is executed in a feedback-loop manner to provide optimal performance at all time.

The overall result of the system and method is a dramatic performance improvement of application server. The system and method can be further tailored to suit tuning other parameters in application server and to meet other system quality requirements such as security.

### BRIEF DESCRIPTION OF THE FIGURES

FIG. 1 shows an illustration of a typical topology of an application server deployment.

FIG. 2 shows an illustration of the structure of the autonomic performance tuning system with the fuzzy control model.

FIG. 3 shows an illustration of determining the set of fuzzy rules.

FIG. 4 shows an illustration of membership function for input variables.

FIG. 5 shows an illustration of membership function for output variables.

FIG. 6 shows an illustration of the fuzzy control algorithm.

### DETAILED DESCRIPTION

Currently, application server plays an important role in a typical e-business environment. It resides in the middle tier of the multi-tiered e-business system architecture and provides the middleware services, such as transactions, security and persistence, to the deployed applications. Experience has shown that the actual number of threads used in the application server has significant effect on the system performance. Application servers provide the thread pool size parameter for administrators to manually adjust the number of threads. However, manual tuning the thread pool size is time consuming and requires highly skilled personnel. In addition, since the workloads of e-business sites tend to vary dynamically and exhibit fluctuations, even if the thread pool size is adjusted well at one point in time, it will show poor performance at other times.

In accordance with an embodiment of the present invention, an autonomic performance tuning system automatically adjusts the number of threads in application server at runtime to achieve optimal response time. It also meets objectives of eliminating manual tuning effort and enabling application server self-tuning and self-optimization.

In accordance with an embodiment of the invention, a system and method for autonomic tuning the number of threads in application server at runtime is provided. In accordance with an embodiment, an autonomic performance tuning system is built to perform monitoring, decision and tuning operations on application server without human intervention. A fuzzy control model is constructed and used in the autonomic performance tuning system. A fuzzy inference engine in the fuzzy control model makes decisions on whether the number of threads needs to be adjusted or not and how many threads should be increased or decreased based on the fuzzy control algorithm and fuzzy rules in the rule base in the fuzzy control model.

In accordance with an embodiment of the invention, during runtime, the system collects the response time of clients' requests and the number of threads handing the requests in application server; the collected response time and the number of threads are fed into the fuzzy control model; the fuzzy inference engine in the fuzzy control model subsequently evaluates activation strength of the available fuzzy rules in the rule base, combines their rule-consequent sides and determines whether the number of threads needs to be adjusted or not and how many threads should be increased or decreased; the results derived from the fuzzy inference engine are translated into actions on the running application server. This process is executed in a feedback-loop manner to provide optimal performance at all time.

The overall result of the system and method is a dramatic performance improvement of application server. The system and method can be further tailored to suit tuning other parameters in application server and to meet other system quality requirements such as security.

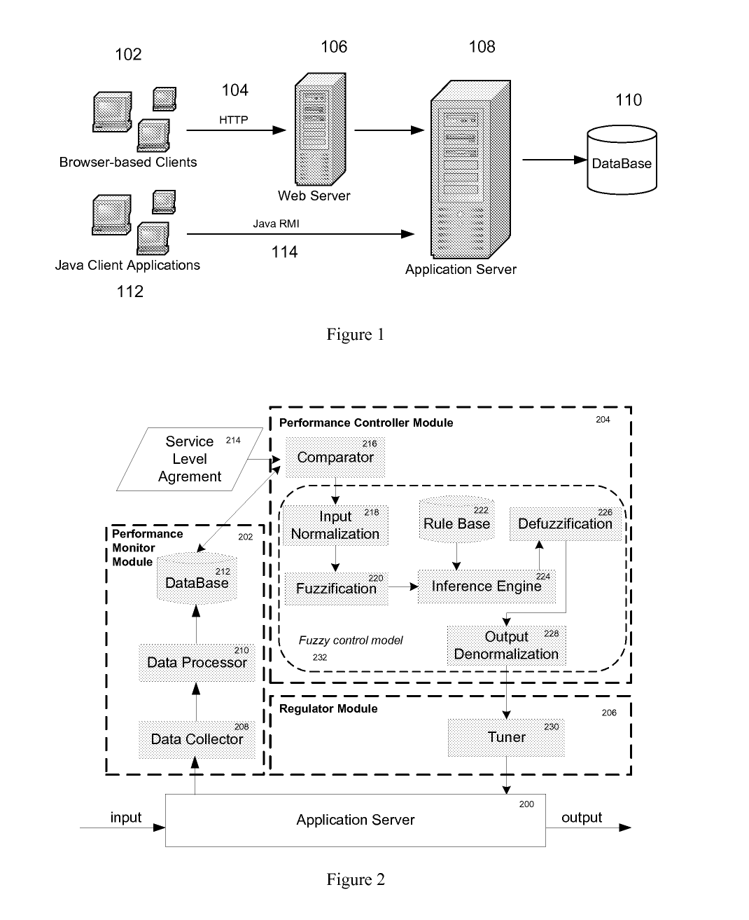

FIG. 2 shows an illustration of the structure of the autonomic performance tuning system with the fuzzy control model, in accordance with an embodiment of the invention. As shown in FIG. 2, the functionalities of the system are grouped into three main logical modules, namely the performance monitor module 202, performance controller module 204 and regulator module 206. The three functional modules constitute an automated, feedback loop. The running environment of the application server 200 is monitored. Which tuning strategy is chosen is decided by the performance controller module 204. The performance of the application server 200 is optimised and adapted to meet its high-level performance goals in the current environment. The resulting system is subsequently monitored and evaluated, optimization and tuning strategies being possibly tuned in effect.

In accordance with an embodiment of the invention, the performance monitor module 202 consists of Data Collector component 208, Data Processor component 210, and a database 212. The Data Collector 208 obtains observations of real-time performance data. Example performance data to collect include request arrival rate and response time etc. The collected data are processed by Data Processor 210 to measurements which are stored in a database 212 so that they can be reused or to meet the statistical requirements.

In accordance with an embodiment of the invention, the regulator module 206 consists of the tuner component 230. The tuner 230 translates the strategy chosen by the Performance Controller Module 204 into actions, and injects the actions into the application server 200 to meet the system performance requirements.

In accordance with an embodiment of the invention, the performance controller module 204 consists of the comparator component 216 and the fuzzy control model 232. The performance controller module 204 is responsible for choosing the right performance tuning strategy for the situation signalled by the monitoring module 202 and Service Level Agreement (SLA) 214. In accordance with an embodiment of the invention, the SLA 214 specifies response time optimization.

In accordance with an embodiment of the invention, the comparator 216 compares the difference between the real-time performance data such as response time and the level of service specified by the agreement. In accordance with an embodiment of the invention, the comparator 216 calculates the changes in the number of threads and response time. The calculated results are feed into the fuzzy control model 232.

In accordance with an embodiment of the invention, the fuzzy control model 232 consist of the six components:

1. Input normalization 218: Perform a scale transformation which maps the actual real-world values of current variables from the comparator component into a normalized universe of discourse.

2. Fuzzification 220: Calculate fuzzy input, that is, convert a crisp value (precise numerical value) into a fuzzy set to make it compatible with the fuzzy set representation of the linguistic variable in the rule-antecedent.

3. Rule Base 222: This includes linguistic fuzzy rules and membership functions of the linguistic values.

Fuzzy Rules

The fuzzy rules in the rule base take the form: IF [conditions] THEN [actions], where conditions and actions are linguistic labels applied to input and out variables respectively. In accordance with an embodiment of the invention, the difference in the number of threads between the current and previous time intervals and the difference in the response time between the current and previous time intervals are input variables, and the number of threads to be changed in next time interval is output variable.

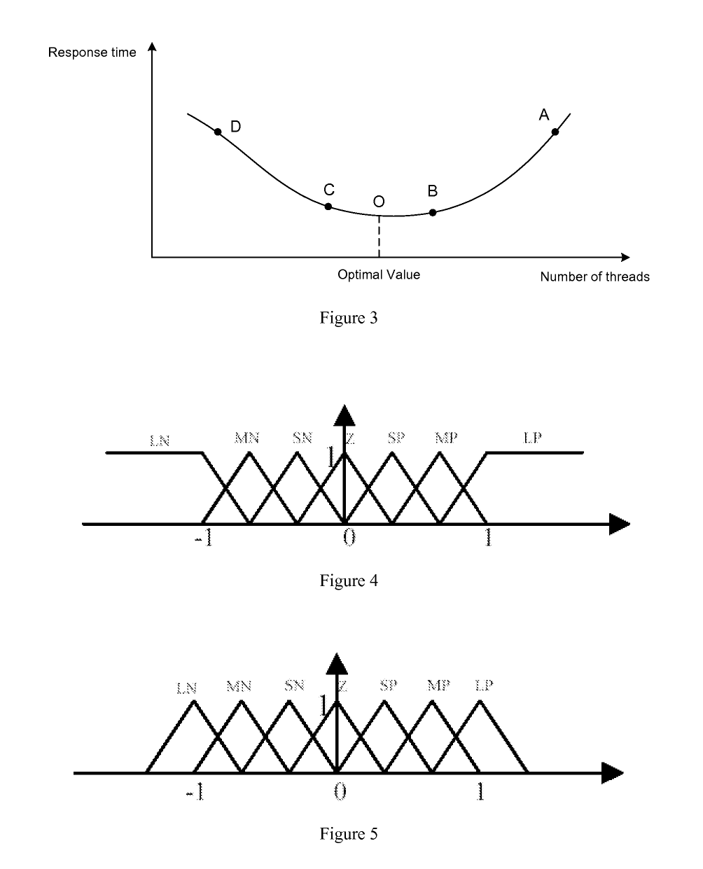

The fuzzy rules are determined based on the experience that the number of threads has the concave upward effect on response time shown as in FIG. 3. To illustrate how to determine the set of fuzzy rules, suppose that the current number of threads is on the right of the optimal value shown as at point A and point B in FIG. 3; we would like to decrease the number of threads. However, since the optimal value is not known, the fuzzy rules should first determine whether it is to the left or to the right. The “IF” part of the fuzzy rules determines the position on the response time curve and the distance from the optimal point. For example, if we increase the number of threads and the response time also shows a large increase, then we are far to the right of the optimal value. The “THEN” part indicates the suggested action, that is, to change the number of threads in the opposite direction (decreasing the number of threads by a large amount). Conversely, if we are to the left of the optimal value at point C and point D, we would like to increase the number of threads. Since we do not know the actual the number of threads that minimize the response time, these rules are described in terms of difference in the number of threads and difference in the response time values between the current and previous time intervals.

Two examples of the fuzzy rules are as follows:

If the difference in the number of threads between the current and previous time intervals is Small Positive and the difference in the response time between the current and previous time intervals is Small Positive, then the number of threads to be changed in next time interval is Small Negative.

If the difference in the number of threads between the current and previous time intervals is Small Positive and the difference in the response time between the current and previous time intervals is Large Positive, then the number of threads to be changed in next time interval is Large Negative.

Membership Functions

The linguistic values of a fuzzy variable can use Gaussian, triangular or trapezoidal shaped membership functions.

In accordance with an embodiment of the invention, triangular membership functions are used. FIG. 4 shows an illustration of membership function for input variables (the difference in the number of threads between the current and previous time intervals and the difference in the response time between the current and previous time intervals). FIG. 5 shows an illustration of membership function for output variable (the number of threads to be changed).

In FIG. 4 and FIG. 5, LN represents Large Negative, MN represents Medium Negative, SN represents Small Negative, Z represents Zero, SP represents Small Positive, MP represents Medium Positive, and LP represents Large Positive, in accordance with an embodiment of the invention.

Other membership functions, for example, Gaussian and trapezoidal shaped membership functions can also be used instead of triangular function.

4. Fuzzy inference Engine 224: Calculate fuzzy output, that is, take the fuzzy sets as input and produce output in the form of fuzzy sets via the evaluating activation strength of every rule and combining their rule-consequent sides. This implements specific fuzzy control algorithms based on a set of linguistic fuzzy rules and a set of membership functions for linguistic values defined in the rule base.

5. Defuzzication 226: Calculate actual output, that is, convert fuzzy output into a crisp value. In accordance with an embodiment of the invention, the centre of gravity method (COG) is used as defuzzification. Other methods of defuzzification, for example, the singleton method, the mean of maximum method, and the weighted sum method, can also be used instead of COG.

COG divides the integral of the membership function of the output fuzzy set into half, and the defuzzified value y out marks the dividing point. Formally, in the continuous case this results in

$${y}_{out} = \frac{\int y {μ}_{{B}^{*}} ( y ) d y}{\int {μ}_{{B}^{*}} ( y ) d y}$$

### (μ_{B*} is the membership function of the output fuzzy set B*)

6. Output Denormalization 228: Map the crisp value of the control output into its real world domain.

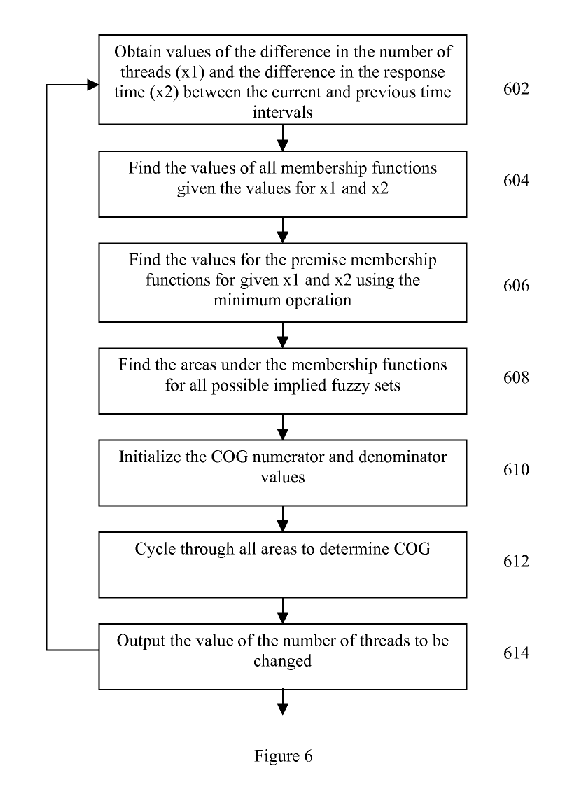

In accordance with an embodiment of the invention, FIG. 6 shows the algorithm used to compute the number of threads to be changed in next time interval given two inputs: the difference in the number of threads (x1) between the current and previous time intervals and the difference in the response time (x2) between the current and previous time intervals. Step 602 obtains x1 and x2 values. Step 604 finds the values of all membership functions given the values for x1 and x2. Step 606 finds the values for the premise membership functions for given x1 and x2 using the minimum operation. Step 608 finds the areas under the membership functions for all possible implied fuzzy sets. Step 610 initializes the COG numerator and denominator values. Step 612 cycles through all areas to determine COG. Step 614 outputs the value of the number of threads to be changed. After step 614, go back to step 602 and continue to compute the next number of threads to be changed given the next two inputs.

The foregoing description of the present invention has been provided for the purposes of illustration and description. It is not intended to be exhaustive or to limit the invention to the precise forms disclosed. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A system for autonomic tuning the number of threads in an application server at runtime, comprising: a performance monitor to collect the response time of clients' requests and the number of threads handing the requests in the application server; a fuzzy performance controller to determine how to adjust the number of threads in the application server based on a fuzzy control algorithm and fuzzy rules; A regulator to translate the decision made by the fuzzy performance controller into actions and injects the actions into the application server.

2. The system of claim 1 wherein said action may be increasing the number of the threads, decreasing the number of the threads or not changing the number of threads in the application server.

3. The system of claim 1 wherein said fuzzy control algorithm consists of the steps of:
a. obtaining the values of the difference in the number of threads and the difference in the response time between the current and previous time intervals;
b. finding the values of all membership functions given the values of the difference in the number of threads and the difference in the response time between the current and previous time intervals;
c. finding the values for the premise membership functions given the values of the difference in the number of threads and the difference in the response time between the current and previous time intervals;
d. finding the areas under the membership functions for all possible implied fuzzy sets;
e. calculating the number of threads needed to be increased or decreased in next time interval by using defuzzification method.

4. The system of claim 3 wherein membership functions can be Gaussian, triangular or trapezoidal shaped membership functions.

5. The system of claim 3 wherein defuzzification method can be the centre of gravity method (COG), the singleton method, the mean of maximum method, or the weighted sum method.

6. The system of claim 1 wherein said fuzzy rules are based on a priori knowledge.

7. A method for autonomic tuning the number of threads in an application server at runtime, comprising the steps of: gathering the response time of clients' requests and the number of threads handing the requests in the application server; calculating the difference in the response time and the difference in the number of threads between the current and previous time intervals; determining the next action based on a fuzzy control algorithm and fuzzy rules stored in fuzzy rule base; and injecting the actions into the application server.

8. The method of claim 7 wherein said action may be increasing the number of the threads, decreasing the number of the threads or not changing the number of threads in the application server.

9. The method of claim 7 wherein said fuzzy control algorithm consists of the steps of:
a. obtaining the values of the difference in the number of threads and the difference in the response time between the current and previous time intervals;
b. finding the values of all membership functions given the values of the difference in the number of threads and the difference in the response time between the current and previous time intervals;
c. finding the values for the premise membership functions given the values of the difference in the number of threads and the difference in the response time between the current and previous time intervals;
d. finding the areas under the membership functions for all possible implied fuzzy sets;
e. calculating the number of threads needed to be increased or decreased in next time interval by using defuzzification method.

10. The method of claim 9 wherein membership functions can be Gaussian, triangular or trapezoidal shaped membership functions.

11. The method of claim 9 wherein defuzzification method can be the centre of gravity method (COG), the singleton method, the mean of maximum method, or the weighted sum method.

12. The method of claim 7 wherein said fuzzy rules are based on a priori knowledge.

13. A computer readable medium, including instructions thereon which when executed cause the computer to perform the steps of: gathering the response time of clients' requests and the number of threads in an application server; calculating the difference in the response time and the difference in the number of threads between the current and previous time intervals; determining the next action based on an fuzzy control algorithm and fuzzy rules stored in fuzzy rule base; and injecting the actions into the application server.

14. The computer readable medium of claim 13 wherein said action may be increasing the number of the threads, decreasing the number of the threads or not changing the number of threads in the application server.

15. The computer readable medium of claim 13 wherein said fuzzy control algorithm consists of the steps of:
a. obtaining the values of the difference in the number of threads and the difference in the response time between the current and previous time intervals;
b. finding the values of all membership functions given the values of the difference in the number of threads and the difference in the response time between the current and previous time intervals;
c. finding the values for the premise membership functions given the values of the difference in the number of threads and the difference in the response time between the current and previous time intervals;
d. finding the areas under the membership functions for all possible implied fuzzy sets;
e. calculating the number of threads needed to be increased or decreased in next time interval by using defuzzification method.

16. The computer readable medium of claim 15 wherein membership functions can be Gaussian, triangular or trapezoidal shaped membership functions.

17. The computer readable medium of claim 15 wherein defuzzification method can be the centre of gravity method (COG), the singleton method, the mean of maximum method, or the weighted sum method.

18. The computer readable medium of claim 13 wherein said fuzzy rules are based on a priori knowledge.
